(19) United States
(12) Patent Application Publication
(10) Pub. No.: US 2026/0336592 A1
(43) Pub. Date: Oct. 29, 2026

(54) Actuator Assembly

(71) Applicant: ZF Active Safety GmbH, Koblenz (DE)

(72) Inventors: Lukas Madzgalla, Lahnstein (DE); Florian Roessinger, Neuwied (DE)

(21) Appl. No.: 19/661,822

(22) Filed: Apr. 29, 2026

(30) Foreign Application Priority Data
Apr. 29, 2025 (DE) 102025116543.2

(51) Int. Cl. B60T 13/74; F16D 55/226; F16D 65/18; F16D 121/24; F16D 125/40

(52) U.S. Cl. CPC B60T 13/746; F16D 55/226; F16D 65/18; F16D 2121/24; F16D 2125/40

(57) ABSTRACT

An actuator assembly (10) for a vehicle brake is specified, having a brake calliper (14) in which an intermediate space (16) for a brake rotor is formed, wherein a brake pad (18), which can be applied to the brake rotor, is arranged in the intermediate space, a spindle drive (20), which has a brake piston (24) in the form of a spindle nut and a spindle (22), driven by an electric motor, for axially moving the brake piston, wherein the brake piston is able to be moved between an extended and a retracted position by axial displacement, and an intermediate washer (28) which is arranged between the brake piston (24) and the brake pad (18) in the engaging direction and bears axially on the brake piston. The brake piston has, on its end face (26) facing the intermediate washer, a curved decoupling surface (30) along which the intermediate washer (28) and the brake piston (24) are movable at least in one direction relative to one another. The intermediate washer (28) is held on the brake piston (24) by means of at least one fastening element (34), which at least partially surrounds both the brake piston (24) and the intermediate washer (28) in the circumferential direction and which is designed such that a relative movement between the brake piston (24) and the intermediate washer (28) along the decoupling surface (30) is possible.

### TECHNICAL FIELD

The invention relates to an actuator assembly for a vehicle brake.

### BACKGROUND

Actuator assemblies in vehicle brakes are used to apply a brake pad to a brake rotor. For this purpose, the actuator assembly usually has a spindle drive, which has a spindle nut and a spindle, driven by an electric motor, for axially moving the spindle nut, wherein an axial feed force for applying the brake pad to the brake rotor is transmitted from the spindle nut to the brake pad.

When the vehicle brake is actuated, high transverse forces act on the brake pad and the spindle nut, thereby causing a bending moment in the actuator assembly. Such transverse forces are undesirable since they result in a loss of performance and efficiency and promote wear of the actuator assembly. The transverse forces that occur change over the lifetime of the actuator assembly on account of lining wear, and this can result in inaccuracies in the activation of the vehicle brake or changes in the braking behaviour.

In known actuator assemblies, a spherical bearing washer is arranged on a spindle bearing face directed away from the brake pad. However, this does not sufficiently eliminate transverse forces in the actuator assembly on account of the relatively large distance from the brake pad.

### SUMMARY

Therefore, the present invention addresses the problem of providing an improved solution for avoiding transverse forces in an actuator assembly of a vehicle brake.

According to the invention, this problem is solved by an actuator assembly for a vehicle brake, having a brake calliper in which an intermediate space for a brake rotor is formed, wherein a brake pad, which can be applied to the brake rotor, is arranged in the intermediate space, a spindle drive, which has a brake piston in the form of a spindle nut and a spindle, driven by an electric motor, for axially moving the brake piston, wherein the brake piston is able to be moved between an extended and a retracted position by axial displacement, and an intermediate washer which is arranged between the brake piston and the brake pad in the engaging direction and bears axially on the brake piston. The brake piston has, on its end face facing the intermediate washer, a curved decoupling surface along which the intermediate washer and the brake piston are movable at least in one direction relative to one another. The intermediate washer is held on the brake piston by means of at least one fastening element, which at least partially surrounds both the brake piston and the intermediate washer in the circumferential direction and which is designed such that a relative movement between the brake piston and the intermediate washer along the decoupling surface is possible.

As a result of the decoupling surface, transverse forces and bending moments in the actuator assembly are largely avoided, and so less wear occurs and consequently the lifetime of the actuator assembly is increased. Since transverse forces are avoided, axial bearings present in the actuator assembly are also relieved of load. Loss forces on account of friction are likewise reduced, with the result that the efficiency of the actuator assembly is optimized.

In a vehicle brake having an actuator assembly according to the invention, a pressure distribution on the brake pad is also particularly uniform, with the result that, as considered over the surface, uniform wear occurs. In other words, angular wear is avoided.

The advantages of the invention are achieved, inter alia, in that the decoupling surface is arranged close to a force application point and transverse forces are no longer transferred into the actuator assembly.

The movement along the decoupling surface, in particular a pivoting movement or a lateral displacement, takes place during the application of the brake pad to the brake rotor, before the maximum clamping force is reached. Specifically, the friction along the decoupling surface increases with increasing clamping force, such that from a certain level of clamping force, in particular at maximum clamping force, compensation at the decoupling surface is scarcely possible any more.

According to one aspect, the intermediate washer extends only along the end face of the brake piston, i.e. not along the circumferential wall of the brake piston. In other words, in a neutral position, the intermediate washer does not extend radially beyond the brake piston.

The decoupling surface is, for example, spherical. A spherical surface is particularly advantageous with regard to the pivoting movement between the intermediate washer and the brake piston. As a result, tilting between the two parts is avoided.

For example, the intermediate washer has, on its face facing the brake piston, a counterface of complementary shape on which the decoupling surface bears extensively. As a result of the counterface of complementary shape of the intermediate washer, the force-transmitting area is maximized. This reduces the point pressure on the components and distributes the forces more uniformly, resulting in reduced material wear. The uniform force distribution also reduces the risk of material fatigue and surface deformation.

A counterface of complementary shape to the decoupling surface furthermore allows a smooth relative movement of the intermediate washer along the decoupling surface of the brake piston when the brake pad is applied and released.

Both the brake piston and the intermediate washer may have, on their outer circumference, at least one circumferentially extending groove in which the fastening element engages in order to fix the brake piston and the intermediate washer axially against one another. The groove may be circumferentially continuous or there may be individual, spaced-apart groove portions.

The engagement of the fastening element in the respective groove in the brake piston and the intermediate washer ensures a firm and secure connection between the brake piston and the intermediate washer. This prevents unintentional displacement or detachment of the components and ensures that they interact reliably with one another during a braking operation.

For example, the fastening element engages in the respective groove in order to press the brake piston and the intermediate washer axially against one another. This ensures continuous contact between the brake piston and the intermediate washer and avoids undesired axial play.

According to one aspect, the fastening element is a fastening ring with a circumferential wall extending in an axial direction, wherein at least one collar protrudes radially inwardly from each axial end of the circumferential wall at an acute angle relative to the circumferential wall. One collar engages, for example, in the at least one groove in the brake piston and the further collar engages in the at least one groove in the intermediate washer. The collars protruding radially inwardly at an acute angle to the circumferential wall can compensate tolerances and thermal expansion by the fastening element to a certain extent.

For example, the fastening ring is manufactured with an undersize, this likewise contributing to tolerance compensation and ensuring that the brake piston and the intermediate washer are pressed axially against one another with sufficient force.

The fastening ring is, in particular, a clamp.

In order to ensure a certain elasticity of the fastening element, the fastening element is made, for example, of spring steel.

The collars protruding from the circumferential wall may be circumferential or may comprise several individual portions.

The fastening element may have been preformed and locked in place during assembly on the brake piston and the intermediate washer. Alternatively, the fastening element may be deformed during assembly. More specifically, the collars can be formed during the assembly of the fastening element.

The grooves may likewise extend in an inclined manner when viewed in profile.

The fastening ring has, for example, circumferentially spaced-apart cutouts which extend alternately from the opposite axial ends of the circumferential wall. This results in a crenelated shape. As a result of the cutouts, the fastening ring has a lower stiffness and as a result can better follow the movements of the intermediate washer relative to the brake piston.

The brake piston may have a closed end face at its end facing the intermediate washer or have an open end face.

In the case of a brake piston that has an open end face, this is a sleeve that is open on both sides and the decoupling surface forms an end wall of the sleeve.

In the case of a brake piston with a closed end face, the brake piston is a sleeve that is open on one side and an end wall of the closed end face has the decoupling surface.

A sleeve-like brake piston that has an open end face has the advantage of a lower weight compared with a brake piston having a closed end face. By contrast, a brake piston with a closed end face has the advantage that no abrasion from the decoupling surface can pass into the interior of the brake piston and thus into the spindle drive.

Both a brake piston with a closed end face and a sleeve-like brake piston that is open on both sides can bear on the intermediate washer with an annular bearing surface. This results in reduced friction along the decoupling surface, thereby simplifying angular compensation along the decoupling surface. In the case of a brake piston with a closed end face, the annular bearing surface is achieved by a central depression in the end face.

If the brake piston has a closed end face, a lubricant may be present between the brake piston and the intermediate washer in order to further reduce friction.

According to one aspect, a sealing element is present, which seals off the interface between the brake piston and the intermediate washer along the circumferential wall, in particular wherein the sealing element surrounds the fastening element. The seal prevents dirt or liquid from penetrating into the interface between the brake piston and the intermediate washer, thereby extending the lifetime of the actuator assembly. Since such a sealing element is present, the fastening element itself does not have to perform a sealing function.

The sealing element may be an integral constituent of a sealing bellows which seals off the actuator assembly toward the intermediate space, thereby reducing the number of individual components.

### BRIEF DESCRIPTION OF THE DRAWINGS

Further advantages and features of the invention will become apparent from the following description and from the accompanying drawings, to which reference is made. In the drawings:

FIG. 1 shows an actuator assembly according to the invention,

FIG. 2 shows the brake piston of the actuator assembly from FIG. 1 with an intermediate washer fastened to the brake piston,

FIG. 3 shows a sectional illustration in the region in which the intermediate washer is fastened to the brake piston,

FIG. 4 shows a fastening element for fastening the intermediate washer to the brake piston,

FIG. 5 shows the intermediate washer, looking onto a spherical surface,

FIG. 6 shows the intermediate washer from FIG. 5, looking onto a bearing surface for a brake pad,

FIG. 7 shows an interface between the intermediate washer and the brake piston with a sealing element covering the interface,

FIG. 8 shows the brake piston of the actuator assembly, and

FIG. 9 shows an actuator assembly according to the invention according to a further embodiment.

### DESCRIPTION

FIG. 1 shows an actuator assembly 10 for a vehicle brake, more specifically for an electromechanically actuable brake.

The actuator assembly 10 comprises a brake calliper 14 in which an intermediate space 16 for a brake rotor is formed, the latter not being illustrated in the figures for the sake of simplicity.

A brake pad 18, which can be applied to the brake rotor, is arranged in the intermediate space.

Furthermore, the actuator assembly 10 comprises a spindle drive 20, which is a ball screw drive in the exemplary embodiment, having a rotatably mounted spindle 22 which is driven by an electric motor and on which a brake piston 24 is mounted. The brake piston is a spindle nut. The spindle 22 serves to axially move the brake piston 24.

Specifically, brake piston 24 is able to be moved between an extended and a retracted position by axial displacement.

The brake piston 24 has an end face 26 facing the brake pad 18.

An intermediate washer 28 is arranged in the engaging direction between the brake piston 24 and the brake pad 18, wherein the intermediate washer 28 bears axially on the brake piston 24, more specifically on the end face 26 thereof.

The brake piston 24 has, on its end face 26 facing the intermediate washer, a curved decoupling surface 30, which is a spherical surface in the exemplary embodiment.

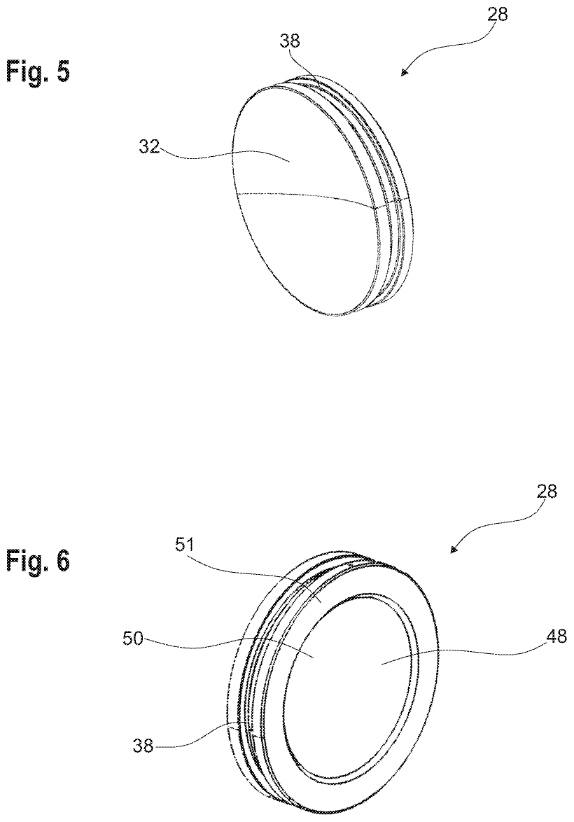

The intermediate washer 28 has, on its face facing the brake piston 24, a counterface 32 of complementary shape on which the decoupling surface 30 bears extensively. The counterface 32 is particularly clearly visible in FIG. 5, which shows the intermediate washer 28 separately.

In the exemplary embodiment, the decoupling surface 30 on the brake piston 24 is convexly curved and the counterface 32 on the intermediate washer 28 is correspondingly concavely curved. However, it is also conceivable for the decoupling surface 30 on the brake piston 24 to be concave and the counterface 32 on the intermediate washer 28 to be convex.

The intermediate washer 28 and the brake piston 24 are movable at least in one direction relative to one another along the decoupling surface 30. In particular, an angular offset with three degrees of freedom is possible along the decoupling surface 30.

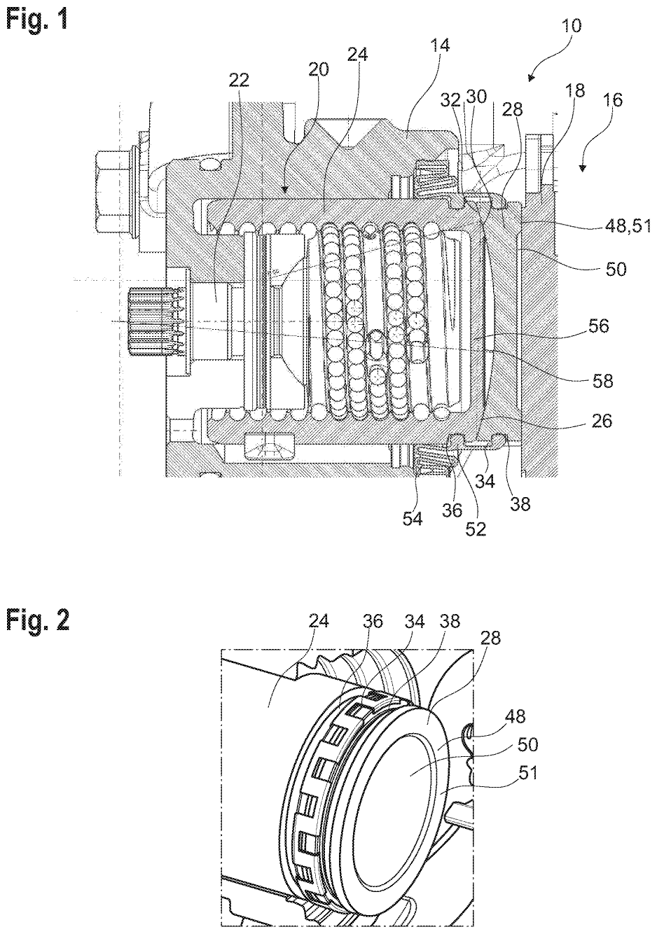

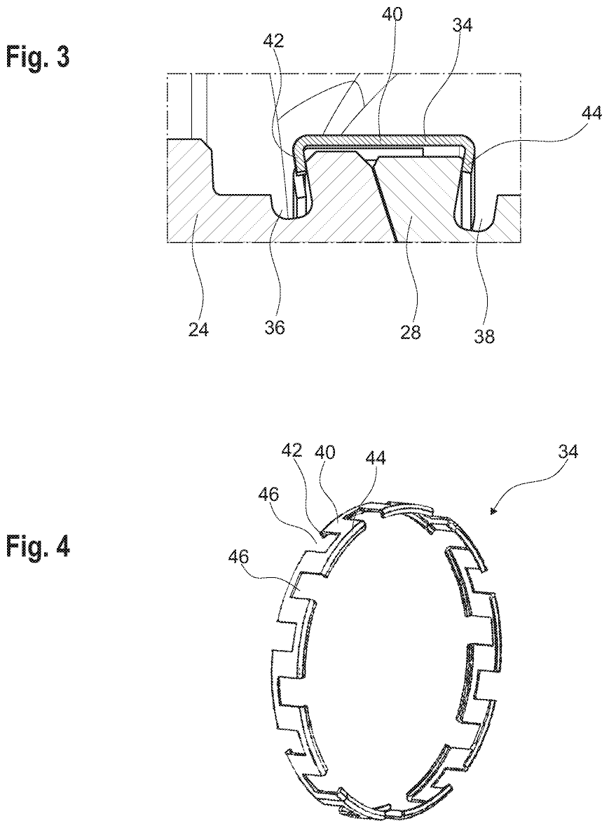

The intermediate washer 28 is held on the brake piston 24 by means of at least one fastening element 34, as is also shown in FIGS. 2 and 3.

The fastening element 34 surrounds the brake piston 24 and the intermediate washer 28 in the circumferential direction.

In this case, the fastening member 34 allows a relative movement between the brake piston 24 and the intermediate washer 28 along the decoupling surface 30, this being achieved by the fastening member 34 having a certain flexibility.

The fastening of the intermediate washer 28 to the brake piston 24 is illustrated in FIGS. 2 and 3.

In FIG. 4, the fastening element 34 is illustrated separately.

As can be seen in FIG. 4, the fastening element 34 is a fastening ring, which has been manufactured in one piece in the exemplary embodiment. It is also conceivable, however, to provide several mutually separate ring segments instead of a single circumferential fastening ring.

Both the brake piston 24 and the intermediate washer 28 each have, on their outer circumference, at least one circumferentially extending groove 36, 38. The grooves 36, 38 are used for fastening the fastening element 34, as can be seen in FIGS. 2 and 3.

Specifically, the fastening element 34 engages in the grooves 36, 38 in order to fix the brake piston 24 and the intermediate washer 28 axially against one another.

In the exemplary embodiment, the grooves 36, 38 are circumferentially continuous, but it is also conceivable for individual, spaced-apart groove portions to be present instead of a continuous groove.

The profile of the fastening element 34 and the profile of the grooves 36, 38 can be seen in FIG. 3.

The fastening element 34 has a circumferential wall 40 extending in an axial direction, wherein at least one collar 42, 44 protrudes radially inwardly from each axial end of the circumferential wall 40 at an acute angle relative to the circumferential wall 40. As a result, the fastening element 34 is in the form of a clamp or is C-shaped when viewed in profile.

The circumferential wall 40 is arranged at a radial distance from the brake piston 24 and from the intermediate washer 28, this likewise contributing to the fact that the intermediate washer 28 is movable along the decoupling surface 30 relative to the brake piston 24.

The collars 42, 44 may be circumferential or have several individual portions.

One of the collars 42 engages in the at least one groove 36 in the brake piston 24 and the further collar 44 engages in the at least one groove 38 in the intermediate washer 28.

As a result, the fastening element 34 presses the intermediate washer 28 and the brake piston 24 axially against one another. In order to enhance this effect and, if necessary, to compensate tolerances, the fastening element may be manufactured with an undersize.

The shape of the grooves 36, 38 can be adapted to the course of the collars 42, 44. This means that the grooves 36, 38 likewise extend in an inclined manner, as can be seen in FIG. 3. Specifically, the grooves 36, 38 extend toward one another in the direction of a central axis of the spindle drive 20.

The fastening element 34 may be made from a spring steel in order to ensure the required flexibility of the fastening element 34.

In order to increase the flexibility of the fastening element 34, the fastening element 34 in the form of a fastening ring has, in the exemplary embodiment, circumferentially spaced-apart cutouts 46, which extend alternately from the opposite axial ends of the circumferential wall 40. When the fastening ring is viewed from the side, the recesses 46 bring about a crenelated shape.

FIG. 6 shows the intermediate washer 28 separately in a further view. In FIG. 6, the end face 48, facing the brake pad 18, of the intermediate washer 28 is shown. At this end face 48, the intermediate washer has a central recess 50, resulting in an annular bearing surface 51 of the intermediate washer 28 with the brake pad 18. This reduces friction between the intermediate washer 28 and the brake pad 18.

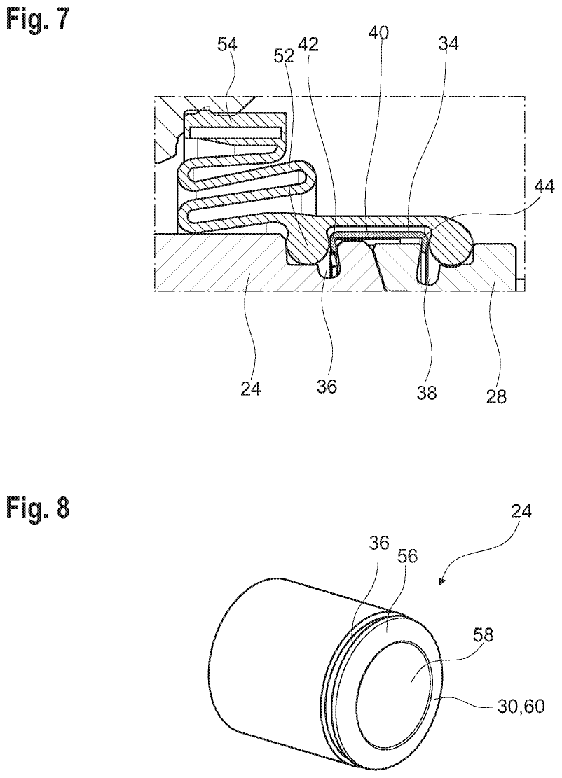

FIG. 7 shows the interfaces, already illustrated in FIG. 3, between the intermediate washer 28 and the brake piston 24. In FIG. 7, a sealing element 52 is additionally illustrated, which seals off the interface between the brake piston 24 and the intermediate washer 28 along the circumferential wall. For this purpose, the sealing element 52 circumferentially surrounds the fastening element 34. In the process, the sealing element 52 extends into the grooves 36, 38.

In the exemplary embodiment, the sealing element 52 is adapted to the shape of the fastening element 34. In particular, the sealing element 52 has a C-shaped profile.

In the exemplary embodiment, the sealing element 52 is an integral constituent of a sealing bellows 54, which seals off the actuator assembly 10 toward the intermediate space 16.

FIG. 8 shows the brake piston 24 of the actuator assembly 10 illustrated in FIG. 1.

In the exemplary embodiment according to FIG. 1, the brake piston 24 has a closed end face 56 at its end facing the intermediate washer 28. The brake piston 24 is consequently a sleeve that is open on one side and an end wall of the brake piston 24 has the decoupling surface 30.

A recess 58 is present in the middle of the end face 56, such that an annular bearing surface 60 of the brake piston 24 arises on the intermediate washer 28. The decoupling surface 30 is thus present on the annular bearing surface 60.

In the case of a closed end face 56, a lubricant may be present between the brake piston 24 and the intermediate washer 28, in particular in the recess 58.

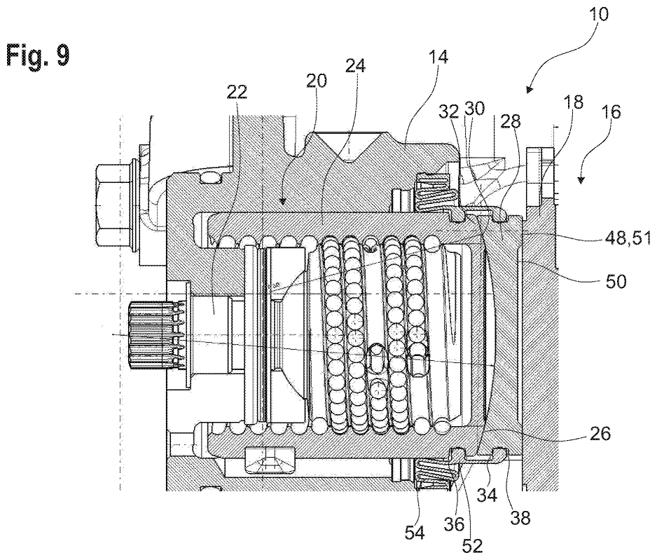

FIG. 9 shows an alternative embodiment of the actuator assembly 10.

The actuator assembly 10 illustrated in FIG. 9 differs from the actuator assembly 10 described above in that the brake piston 24 has an open end face at its end facing the intermediate washer 28. In other words, the brake piston 24 is a sleeve that is open on both sides. In this case, the decoupling surface 30 is formed by an annular end wall of the sleeve.

There is no lubricant in this case.

1. Actuator assembly (10) for a vehicle brake, having
a brake calliper (14) in which an intermediate space (16) for a brake rotor is formed, wherein a brake pad (18), which can be applied to the brake rotor, is arranged in the intermediate space,
a spindle drive (20), which has a brake piston (24) in the form of a spindle nut and a spindle (22), driven by an electric motor, for axially moving the brake piston, wherein the brake piston is able to be moved between an extended and a retracted position by axial displacement, and
an intermediate washer (28) which is arranged between the brake piston (24) and the brake pad (18) in the engaging direction and bears axially on the brake piston, wherein the brake piston has, on its end face (26) facing the intermediate washer, a curved decoupling surface (30) along which the intermediate washer (28) and the brake piston (24) are movable at least in one direction relative to one another,
wherein the intermediate washer (28) is held on the brake piston (24) by means of at least one fastening element (34), which at least partially surrounds both the brake piston (24) and the intermediate washer (28) in the circumferential direction and which is designed such that a relative movement between the brake piston (24) and the intermediate washer (28) along the decoupling surface (30) is possible.

2. Actuator assembly (10) according to claim 1, wherein the decoupling surface (30) is spherical.

3. Actuator assembly (10) according to claim 1, wherein the intermediate washer (28) has, on its face facing the brake piston (24), a counterface (32) of complementary shape on which the decoupling surface (30) bears extensively.

4. Actuator assembly (10) according to claim 1, wherein both the brake piston (24) and the intermediate washer (28) have, on their outer circumference, at least one circumferentially extending groove (36, 38) in which the fastening element (34) engages in order to fix the brake piston (24) and the intermediate washer (28) axially against one another.

5. Actuator assembly (10) according to claim 4, wherein the fastening element (34) engages in the respective groove (36, 38) in order to press the brake piston (24) and the intermediate washer (28) axially against one another.

6. Actuator assembly (10) according to claim 4, wherein the fastening element (34) is a fastening ring, with a circumferential wall (40) extending in an axial direction, wherein at least one collar (42, 44) protrudes radially inwardly from each axial end of the circumferential wall at an acute angle relative to the circumferential wall, wherein one collar engages in the at least one groove (36) in the brake piston (24) and the further collar engages in the at least one groove (38) in the intermediate washer (28).

7. Actuator assembly (10) according to claim 6, wherein the fastening ring has recesses (46) that are spaced apart from one another in the circumferential direction and extend alternately from the opposite axial ends of the circumferential wall (40).

8. Actuator assembly (10) according to claim 1, wherein the brake piston (24) has a closed end face (56) at its end facing the intermediate washer (28) or has an open end face.

9. Actuator assembly (10) according to claim 1, wherein the brake piston (24) bears on the intermediate washer (28) with an annular bearing face (60).

10. Actuator assembly (10) according to claim 1, wherein the brake piston (24) has a closed end face (56) and a lubricant is present between the brake piston (24) and the intermediate washer (28).

11. Actuator assembly (10) according to claim 1, wherein a sealing element (52) is present, which seals off the interface between the brake piston (24) and the intermediate washer (28) along the circumferential wall, in particular wherein the sealing element surrounds the fastening element (34).

12. Actuator assembly (10) according to claim 11, wherein the sealing element (52) is an integral constituent of a sealing bellows (54) which seals off the actuator assembly (10) toward the intermediate space (16).
